(19) United States
(12) Patent Application Publication
(10) Pub. No.: US 2011/0298333 A1
(43) Pub. Date: Dec. 8, 2011

(54) DIRECT CONVERSION OF NANOSCALE THERMAL RADIATION TO ELECTRICAL ENERGY USING PYROELECTRIC MATERIALS

(76) Inventor: Laurent G. Pilon, (US)

(21) Appl. No.: 13/155,288

(22) Filed: Jun. 7, 2011

Related U.S. Application Data
(60) Provisional application No. 61/352,284, filed on Jun. 7, 2010.

(51) Int. Cl. H02N 11/00

(52) U.S. Cl. 310/306

(57) ABSTRACT

The embodiment provided herein are directed to a pyroelectric (PE) energy converter which is capable of combining nanoscale thermal radiation and pyroelectric energy conversion for harvesting low grade waste heat. The converter advantageously makes use of the enhanced radiative heat transfer across a nanosize gap to achieve high operating frequencies or large temperature oscillations in a composite PE plate. The PE energy converter generally comprises a hot source, a cold source, and a PE plate, wherein the PE plate oscillates between the hot and cold source and the PE plate can be subjected to a power cycle in the displacement-electric field diagram. The hot and cold sources of the converter can be coated with SiO₂ absorbing layer to further enhance the radiative heat fluxes. The converter comprising a PE plate made of 60/40 P(VDF-TrFE) operated between 273 K and 388 K experiences a maximum efficiency of 0.2% and a power density of 0.84 mW/cm². The converter comprising a PE plate made of 0.9PMN-PT composite thin films achieve a higher efficiency and a larger power output namely 1.3% and 6.5 mW/cm², respectively, for a temperature oscillation amplitude of 10 K around 343 K at 5 Hz.

### CROSS-REFERENCE TO RELATED APPLICATIONS

This application claims the benefit of provisional application Ser. No. 61/352,284, filed Jun. 7, 2010, which is fully incorporated herein by reference.

### FIELD

The present disclosure relates generally to pyroelectric energy converters, and more particularly to a direct conversion of nanoscale thermal radiation to electrical energy using pyroelectric materials.

### BACKGROUND INFORMATION

Industrial and developing nations are facing challenges of meeting the rapidly expanding energy needs without further impacting the climate and the environment. However, a significant amount of energy resource consumption is lost in the form of waste heat released as a by-product of power, refrigeration, or heat pump cycles. Most of the lost energy appears as low grade waste heat which is hard to reuse because of its low temperature.

Pyroelectric (PE) energy converters offer a direct energy conversion technology by transforming waste heat directly into electricity. Conventional PE energy converters make use of the PE effect occurring in PE materials to create a flow of charge to or from the surface of a material as a result of successive heating or cooling cycles.

PE materials feature a spontaneous polarization, which is defined as the average electric dipole moment per unit volume in absence of an applied electric field. This polarization depends strongly on temperature due to the PE material's crystallographic structure. The displacement of the atoms from their equilibrium positions gives rise to the spontaneous polarization resulting in the PE effect. At steady-state (dT/dt=0), the polarization of the PE material is constant and no current is generated. However, when the PE material is heated (dT/dt>0), the polarization decreases as dipole moments begin to lose their orientation. As a result, the number of charges stored at the surface of the PE material decreases, resulting in an electric current flowing through the external circuit. When the PE material is cooled (dT/dt<0), the dipole moments regain their orientation which increases the spontaneous polarization and allows for more charges to be stored at the surface of the material, thereby reversing the electric current flow. The direction of polarization is usually constant throughout a PE material, but in some materials this direction can be changed by applying a coercive “poling” electric field. This subclass of PE materials are called ferroelectric materials.

It is generally understood that all ferroelectric materials are PE and all PE materials are piezoelectric. However, the converse is not true. The polarization of ferroelectric materials vanishes beyond the Curie temperature (T_{Curie}) when the material undergoes a phase transition from ferroelectric to paraelectric and the spontaneous polarization disappears. It is understood that this phase transition process from ferroelectric to paraelectric results in a large charge release.

As mentioned above, conventional PE energy converters make use of PE materials subjected to a thermodynamic cycle to create a flow of charge to or from the surface of a material as a result of successive heating and cooling. It is understood that PE energy conversion is possible by alternatively placing the PE material sandwiched between two electrodes in contact with a hot and cold reservoir. Unfortunately, however, this process is highly irreversible, and theoretical analysis on such a PE energy conversion system predicts a low efficiency and a small power density. Moreover, the operating frequency of such a conventional PE energy converter devices is usually small (˜0.1 Hz) and limited by convective heat transfer between the PE material and the working fluid subjected to oscillatory laminar flow between a hot and a cold source. In turn, this restricts the performance of the device.

Thus, it is desirable to provide systems and methods that facilitate improved PE energy conversion in a device for harvesting waste heat with large power output and energy efficiency.

### SUMMARY

The present disclosure relates generally to pyroelectric (PE) energy converters, and more particularly to a PE energy converter capable of achieving direct conversion of nanoscale thermal radiation to electrical energy using PE materials.

In fact, thermal radiative heat transfer takes place at the speed of light. In addition, the net radiation flux in vacuum between two surfaces at different temperatures can be increased by several orders of magnitude if they are separated by a distance comparable to or smaller than the characteristic wavelength given by Wien's displacement law. Thus, nanoscale radiative heat transfer has the potential to increase the operating frequency of pyroelectric energy converters, resulting in a larger power density and efficiency.

The PE energy converter generally comprises a hot source, a cold source, and a PE plate, wherein the hot source and the cold source can be in parallel, and wherein the PE plate is configured to oscillate between the hot source and the cold source. In one embodiment, the PE plate is comprised of a PE material film sandwiched between electrodes, which are used to collect electric charges and to apply an electric field across the converter. The PE material film can be made of 60/40 porous vinylidene fluoride-trifluoroethylene (P(VDF-TrFE)) and the electrodes can be made of aluminum. The hot source and the cold source can also be made of aluminum. In one embodiment, the hot source and the cold source are aluminum plates capable of being held at different temperatures.

In a preferred embodiment, the PE plate oscillates between the hot plate and the cold plate wherein the PE plate is alternatively brought in from a relatively far distance to a close proximity to either the hot plate or the cold plate within a distance equal to or smaller than the radiation peak wavelength, λₘₐₓ, which is given by Wien's displacement law (λₘₐₓT=2898 mm K), wherein T is either one of the temperature of the hot plate, Tₕ, or the temperature of the cold plate, T_{c}. In other words, the PE plate preferably oscillates between the hot plate and the cold plate such that when the PE plate travels towards hot plate in one direction, the distance between the hot plate and the PE plate (d_{PE,h}) decreases from a length that is larger than the radiation peak wavelength, λₘₐₓ, where λₘₐₓTₕ=2898 mm K, to a length that is equal to or smaller than the radiation peak wavelength, λₘₐₓ, where λₘₐₓTₕ=2898 mm K. Alternatively, when the PE plate travels towards the cold plate, in the opposite direction, the distance between the cold plate and the PE plate (d_{PE,c}) decreases from a length that is larger than the radiation peak wavelength, λₘₐₓ, where λₘₐₓT_{c}=2898 mm K, to a length that is equal to or smaller than the radiation peak wavelength, λₘₐₓ, where λₘₐₓT_{c}=2898 mm K.

In another embodiment, the PE plate oscillates between the hot plate and the cold plate wherein the PE plate is alternatively brought in thermal contact with either the hot plate or the cold plate. Both sides of the PE plate and the inner surfaces of the hot plate and the cold plate can be treated to minimize the thermal contact resistance between them.

In one embodiment, silicon dioxide (SiO₂) thin films of thickness L_{SiO}_{₂}, which act as absorbing layers capable of emitting and absorbing nanoscale radiation to enhance the radiative heat flux between the hot plate and the cold plate, can be coated on both sides of the PE plate and on the inner surfaces of the hot plate and the cold plate.

The PE plate can also be mounted on actuators, which allow the PE plate to oscillate between the hot plate and the cold plate. In one embodiment, the actuators may be configured to piezoelectric pillars. In operation, the converter can be operated under vacuum to minimize both friction on the oscillating PE plate and heat losses to the surroundings.

Other systems, methods, features, and advantages of the example embodiments will be or will become apparent to one with skill in the art upon examination of the following figures and detailed description.

### BRIEF DESCRIPTION OF THE FIGURES

The details of the embodiments, including fabrication, structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 depicts a schematic illustration of a pyroelectric energy converter generally comprising a hot source, a cold source, and a pyroelectric plate.

FIG. 2 depicts a schematic illustration of the pyroelectric plate, removed from the converter.

FIG. 3 illustrates a schematic model used to evaluate a generic heat flux function of a first semi-infinite medium separated by a distance from a second semi-infinite medium.

FIG. 4 is a graph comparing the results obtained for the contributions of s- and p-polarizations to the radiative heat flux between a first semi-infinite aluminum medium held at T₁=0 K and a second semi-infinite aluminum medium held at T₂=273 K, separated by a distance d.

FIG. 5 illustrates a graph comparing the results obtained for the heat transfer coefficient between two semi-infinite mediums made of SiC material held at T₁=300 K and T₂=301 K as a function of distance d.

FIG. 6 illustrates one embodiment of the PE plate comprising a PE material sandwiched between two aluminum electrodes and wherein the aluminum electrodes are coated with a SiO₂ absorbing layer to enhance the radiative heat flux.

FIG. 7 illustrates an electric displacement versus electric field diagram for typical PE material at temperatures Tₕₒₜ and T_{cold} along with the Olsen cycle.

FIG. 8 illustrates the temperature oscillation of the PE plate comprising the PE material film made of 60/40 P(VDF-TrFE) as a function of time oscillating at 1 Hz between the cold plate and the hot plate held at T_{c}=273 K and Tₕ=388 K, with and without SiO₂ absorbing layers.

FIG. 9 shows the block diagram of the solution procedure used to predict the temperature of the PE plate as a function of time.

FIGS. 10(a)-(b) illustrate the temperature oscillations of the PE plate comprising the PE material film made of 60/40 P(VDF-TrFE) with SiO₂ absorbing layers as a function of time where the cold plate is held at T_{c}=273 K and the hot plate is held at Tₕ=388 K; FIG. 10(a) illustrates the temperature oscillations at a frequency f=0.6 Hz and FIG. 10(b) illustrates the temperature oscillations at a frequency f=1.2 Hz.

FIG. 11 illustrates the minimum and maximum temperatures of oscillations of the PE plate comprising the PE material film made of 60/40 P(VDF-TrFE) with SiO₂ absorbing layers as a function of frequency where the cold plate is held at T_{c}=273 K and the hot plate is held at Tₕ=388 K.

FIG. 12 illustrates the maximum and minimum temperatures of oscillation of the PE plate comprising the PE material film made of 0.9 lead magnesium niobate-lead titanate (0.9 PMN-PT) with SiO₂ absorbing layers as a function of frequency where the cold plate is held at T_{c}=283 K and the hot plate is held at Tₕ=383 K.

FIG. 13 illustrates the efficiency ratios η/η_{Carnot} and η/η_{CA} as a function of frequency for one embodiment of the PE plate comprising the PE material film made of a single 60/40 P(VDF-TrFE) film and another embodiment of the PE plate comprising multiple PE material films made of 0.9PMN-PT.

### DETAILED DESCRIPTION

Described herein is a pyroelectric energy converter 10 for use in the direct conversion of nanoscale thermal radiation to electrical energy using pyroelectric materials. The converter 10 advantageously achieves a large heat transfer rate and fast temporal temperature oscillation and thus very large power output.

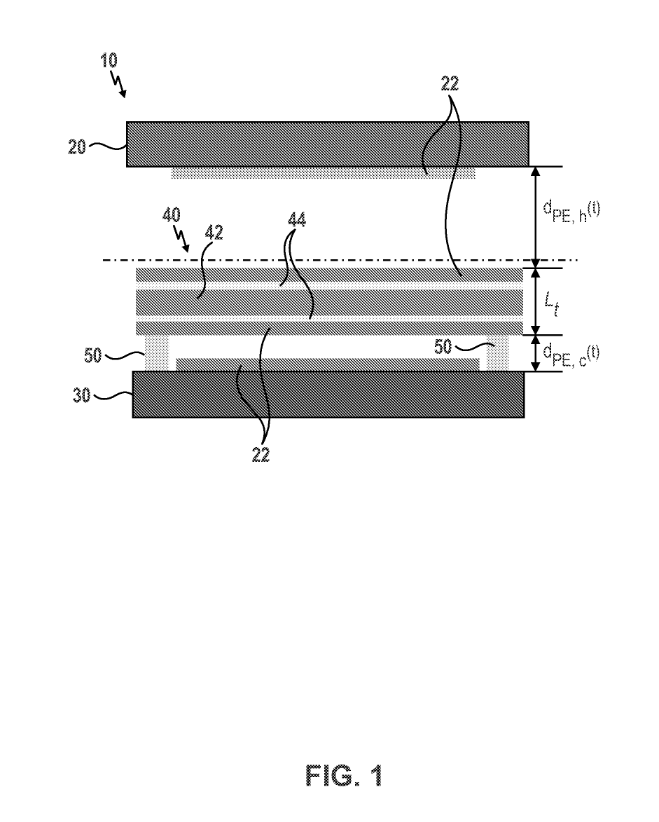

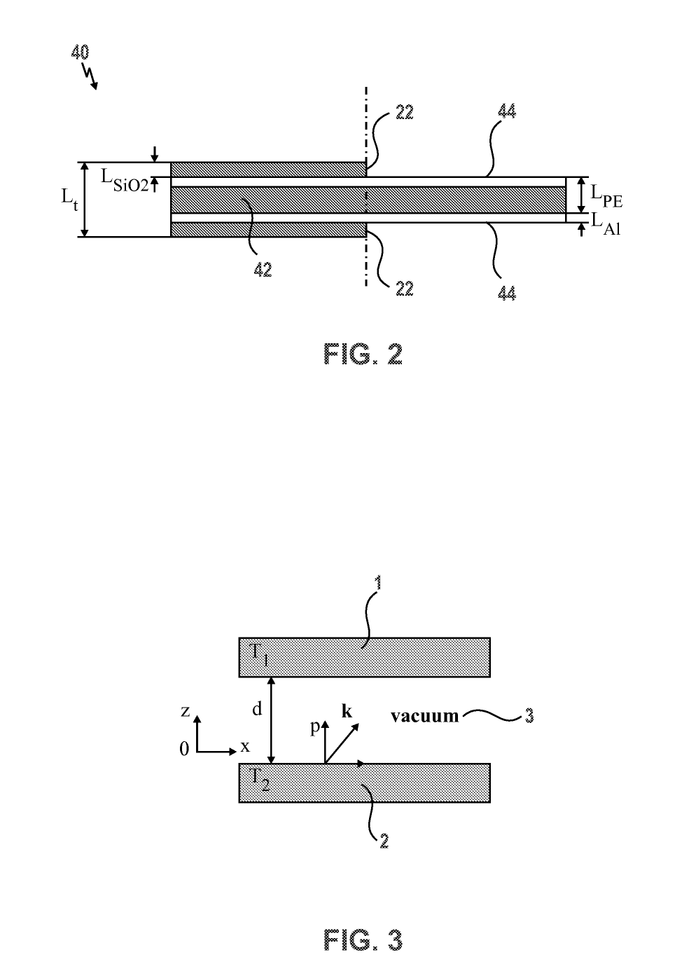

As illustrated in FIG. 1, converter 10 generally comprises a hot source 20, a cold source 30, and a pyroelectric (PE) plate 40, wherein the hot source 20 and the cold source 30 are in parallel, and wherein the PE plate 40 is configured to oscillate between the hot source 20 and the cold source 30. It is appreciated that the hot source 20 and the cold source 30 do not necessarily have to be perfectly parallel. In one embodiment, the hot source 20 is made of an aluminum plate and the cold source 30 is also made of an aluminum plate, as illustrated in FIG. 1. FIG. 2 illustrates the PE plate 40 removed from the converter 10. In one embodiment, the PE plate 40 is comprised of a pyroelectric (PE) material film 42 sandwiched between electrodes 44, as illustrated in FIG. 2. The electrodes 44 of the PE plate 40 are used to collect electric charges and to apply an electric field. As illustrated in the schematic diagram of the PE plate 40 in FIG. 2, the PE material film 42 has a thickness L_{PE}, and the electrodes 44 each have a thickness L_{Al}. In one embodiment, the electrodes 44 of the PE plate 40 can be made of aluminum (Al). Silicon dioxide (SiO₂) thin films 22 of thickness L_{SiO}_{₂} can also be coated on both sides of the PE plate 40 and on the inner surfaces of the hot plate 20 and the cold plate 30. SiO₂ thin films 22 act as absorbing layers, which emit and absorb nanoscale radiation to enhance the radiative heat transfer between the hot plate 20 and the cold plate 39. As illustrated in FIG. 1, the total thickness of the PE plate 40 is Lₜ.

The electrodes 44 of the PE plate 40 are preferably made of an electrically-conducting material. As mentioned above, the electrodes 44 can be made of aluminum. The electrodes 44 can also be made of any other electrically-conducting material, such as gold, nickel, or indium tin oxide (ITO). The thin films 22 can be made of SiO₂. It is appreciated, however, that the thin films 22 can also be made of other materials with a large emissivity at the operating temperatures. By way of example, the thin films 22 can be made of silicon carbide (SiC).

While the hot source 20 and the cold source 30 are described as being made of aluminum plates, it is appreciated that the hot source 20 and the cold source 30 can be made of various materials and embodiments capable of sufficiently heating and cooling the PE plate 40 as the PE plate oscillates between the hot plate 20 and the cold plate 30, respectively. By way of example, the hot source 20 and the cold source 30 can be made of copper plates or other suitable metallic materials.

Also as illustrated in FIG. 1, the distance between the hot plate 20 and the PE plate 40 is denoted by d_{PE,h} and the distance between the cold plate 30 and the PE plate 40 is denoted by d_{PE,c}. In operation of the converter 10, the hot plate 20 is held at a temperature Tₕ and the cold plate 30 is held at a temperature T_{c}. As illustrated in FIG. 1, the PE plate 40 is mounted on actuators 50, which allow the PE plate 40 to oscillate between the hot plate 20 and the cold plate 30. In one embodiment, the actuators 50 are made of piezoelectric material pillars, where the piezoelectric material pillars are configured to the PE plate 40 in such a way as to oscillate the PE plate 40 between the hot plate 20 and the cold plate 30. In operation, the converter 10 can be operated under vacuum to minimize both friction on the oscillating PE plate 40 and heat losses to the surroundings.

In a preferred embodiment, the PE plate 40 oscillates between the hot plate 20 and the cold plate 30 wherein the PE plate 40 is alternatively brought in from a relatively far distance to a close proximity to either the hot plate 20 or the cold plate 30 within a distance equal to or smaller than the radiation peak wavelength, λₘₐₓ, which is given by Wien's displacement law (λₘₐₓT=2898 mm K), wherein T is either one of the temperature of the hot plate, Tₕ, or the temperature of the cold plate, T_{c}. In other words, the PE plate 40 preferably oscillates between the hot plate 20 and the cold plate 30 such that when the PE plate 40 travels towards hot plate 20 in one direction, the distance between the hot plate 20 and the PE plate 40 (d_{PE,h}) decreases from a length that is larger than the radiation peak wavelength, λₘₐₓ, where λₘₐₓTₕ=2898 mm K, to a length that is equal to or smaller than the radiation peak wavelength, λₘₐₓ, where λₘₐₓTₕ=2898 mm K. Alternatively, when the PE plate 40 travels towards the cold plate 30, in the opposite direction, the distance between the cold plate 30 and the PE plate 40 (d_{PE,c}) decreases from a length that is larger than the radiation peak wavelength, λₘₐₓ, where λₘₐₓT_{c}=2898 mm K, to a length that is equal to or smaller than the radiation peak wavelength, λₘₐₓ, where λₘₐₓT_{c}=2898 mm K.

In another embodiment, the PE plate 40 oscillates between the hot plate 20 and the cold plate 30 wherein the PE plate 40 is alternatively brought in thermal contact with either the hot plate 20 or the cold plate 30. In the present embodiment, both sides of the PE plate 40 and the inner surfaces of the hot plate 20 and the cold plate 30 can be treated to minimize the thermal contact resistance between them. By way of example, both sides of the PE plate 40 and the inner surfaces of the hot plate 20 and the cold plate 30 can be coated with a thermal interface material such as high thermal conductivity paste, lubricant, or a forest of carbon nanotubes.

In operation, the converter 10, having an elementary element of the composite PE plate 40 with a unit surface area and thickness Lₜ, is governed by the following energy conservation equation:

$${( ρ {c}_{p} )}_{eff} {L}_{t} \frac{d {T}_{PE}}{d t} = {q}_{h -> PE}^{″} ( {T}_{h} , {T}_{PE} , {d}_{PE , h} ) - {q}_{PE -> c}^{″} ( {T}_{PE} , {T}_{c} , {d}_{PE , c} ) \qquad ( 1 )$$

where (ρcₚ)_{eff} represents the effective volumetric heat capacity of the composite PE plate 40, q″_{h→PE} represents the net radiative heat flux from the hot plate 20 to the PE plate 40, and q″_{PE→c} represents the net radiative heat flux from the PE plate 40 to the cold plate 30.

The generic radiative heat flux function, q″_{1→2}(T₁,T₂,d), appearing in Equation (1), accounts for the far field (propagative wave interference) and the near field (evanescent photon tunneling) contributions to the total radiative heat flux between a first medium 1 and a second medium 2, where the first medium 1 and the second medium 2 are separated by a distance d and where the first medium 1 is held at a temperature T₁ and the second medium 2 is held at a temperature T₂, as illustrated in FIG. 3. When the first medium 1 and second medium 2 are assumed to be semi-infinite, i.e., the end effects are neglected, the generic radiative heat flux function, q″_{1→2}(T₁,T₂,d), can be estimated from fluctuation electrodynamic theory and can written in the following general form:

q″_{1→2}(T₁,T₂,d)=∫₀^{∞}[I_{bω}⁰(T₁)−I_{bω}⁰(T₂)]×Φ₁₂(ω,d)dω (2)

where the function, I_{bω}⁰(T), represents the spectral blackbody radiation intensity at frequency ω and temperature T. The spectral blackbody radiation intensity, I_{bω}⁰(T), can be expressed by the Planck's law as:

$${I}_{b ω}^{0} ( T ) = \frac{{ω}^{2}}{4 {π}^{3} {c}^{2}} \frac{ℏω}{( {e}^{ℏω / {k}_{B} T} - 1 )} \qquad ( 3 )$$

where is the reduced Planck's constant (=1.056×10⁻³⁴ Js), c is the speed of light in a vacuum (c=2.998×10⁸ m/s), and k_{B} is the Boltzmann's constant (k_{B}=1.3806×10⁻²³ J/K).

Further, the function Φ₁₂(ω,d), appearing in Equation (2), corresponds to the spectral efficiency of the radiative heat transfer between the first medium 1 and the second medium 2 separated by a distance d, as illustrated in FIG. 3. The spectral efficiency function, Φ₁₂(ω,d), can be expressed as:

$${Φ}_{12} ( ω , d ) = {\sum }_{j = s , p} ( {\int }_{q = 0}^{\frac{ω}{c}} \frac{{qc}^{2}}{{ω}^{2}} \frac{( 1 - {\vert {r}_{31}^{j} \vert}^{2} ) ( 1 - {\vert {r}_{32}^{j} \vert}^{2} )}{{\vert 1 - {r}_{31}^{j} {r}_{32}^{j} {e}^{- 2 i pd} \vert}^{2}} d q ) + {\sum }_{j = s , p} ( {\int }_{q = ω / c}^{∞} \frac{{qc}^{2}}{{ω}^{2}} \frac{4 {e}^{- 2 \vert p \vert d} Im ( {r}_{31}^{j} ) Im ( {r}_{32}^{j} )}{{\vert 1 - {r}_{31}^{j} {r}_{32}^{j} {e}^{- 2 \vert p \vert d} \vert}^{2}} d q ) \qquad ( 4 )$$

where p and q are the z- and x-components of the wavevector in the vacuum gap, respectively. The z-component (p) and the x-component (q) are related by p=\sqrt{(ω/c)²−q²} where ω/c is the amplitude of the wavevector. As noted in Equation (4), the summation is made to account for both s- and p-polarizations. The first summation term on the right-hand side of Equation (4) corresponds to the far field radiation flux. Integration over q from 0 to ω/c accounts for all propagative waves and results in the Stefan-Boltzmann law. The second summation term on the right-hand side of Equation (4) represents the contribution of the near field radiation flux to the total radiative heat flux. Integration over q from ω/c to infinity stands for the evanescent waves or the tunneling heat flux. The amplitude of evanescent waves decreases exponentially as the distance d between the first medium 1 and the second medium 2 increases. The near field second summation term is negligible compared with the far field first summation term when the distance d between the first medium 1 and the second medium 2 is large. Equation (4) includes integration over the azimuthal angle and accounts for interferences and polarizations coupling between the first medium 1 and second medium 2.

The Fresnel coefficients for s- and p-polarized electromagnetic waves incident from a vacuum medium 3 on the interface with the first medium 1 are denoted by r₃₁ and expressed, for s and p-polarizations as:

$${r}_{31}^{s} = \frac{p - {s}_{1}}{p + {s}_{1}} and {r}_{31}^{p} = \frac{{ɛ}_{r 1} p - {s}_{1}}{{ɛ}_{r 1} p + {s}_{1}} \qquad ( 5 )$$

where ∈ᵣ₁ is the complex dielectric constant of the first medium 1 while s₁ is the z-component of the wavevector in the first medium 1, and can be expressed as s₁=\sqrt{∈ᵣ₁ω²/c²−q²}. Likewise, the Fresnel coefficients r₃₂^{s} and r₃₂^{p} between the second medium 2 and the vacuum medium 3 are obtained in a similar manner. It is appreciated that the Fresnel coefficients for s- and p-polarized electromagnetic waves incident from the vacuum medium 3 depend on the angular frequency ω of the wavevector.

To compute the Fresnel coefficients as a function of angular frequency ω, as required in Equation (5), it is necessary to understand the constitutive relationships for the dielectric constant ∈ᵣᵢ of each medium. It is commonly accepted that the Drude model will adequately predict the complex dielectric constant of metals. The Drude model for a metal medium (e.g., aluminum or silver) can be expressed as:

$${ɛ}_{r} ( ω ) = 1 - \frac{{ω}_{p}^{2}}{{ω}^{2} - iγω} \qquad ( 6 )$$

where ωₚ represents the plasma frequency of the metal medium and γ is the relaxation frequency of the metal medium.

It is also commonly accepted that the Lorentz model will provide an acceptable calculation for the dielectric constant of dielectric materials (e.g., SiO₂). The Lorentz model for a dielectric medium can be expressed as:

$${ɛ}_{r} ( ω ) = 1 - \frac{{ω}_{p}^{2}}{{ω}_{0}^{2} - {ω}^{2} - iγω} \qquad ( 7 )$$

where ω₀ represents the oscillator frequency of the dielectric medium. It is appreciated that multiple oscillators can be accounted for by adding terms similar to the second term on the right-hand side of Equations (6) and (7) with different and respective oscillator frequencies ω₀, plasma frequencies ωₚ, and relaxation frequencies γ.

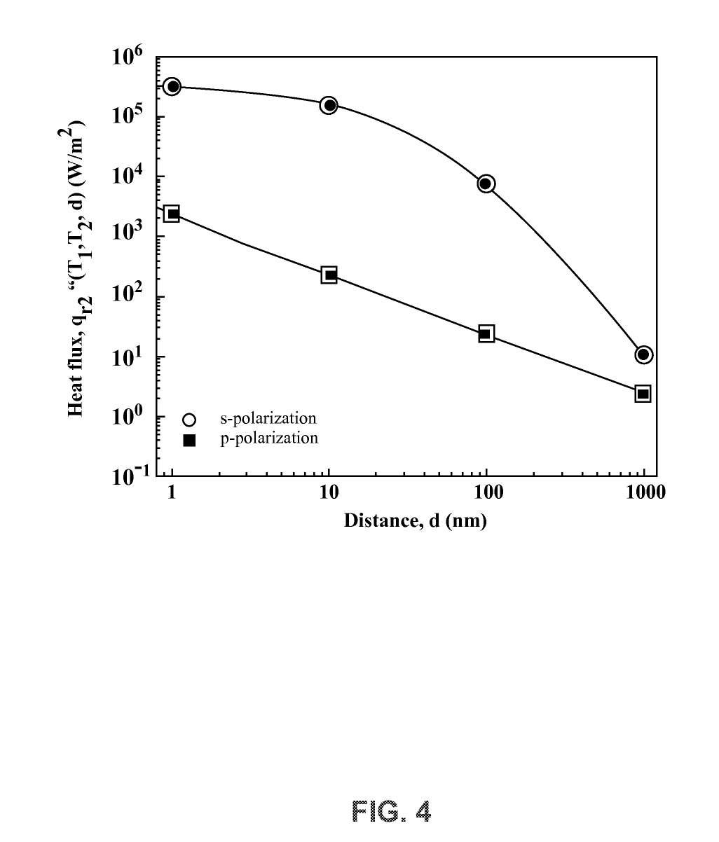

In one embodiment, the first medium 1 and the second medium 2 are made of silver (Ag) where the first silver medium 1 is held at a temperature T₁=273 K and the second silver medium 2 is held at a temperature T₂=0 K. It is appreciated that the radiation heat flux between the two silver mediums can be calculated using the Drude model with parameters plasma frequency, ωₚ=1.4×10¹⁶ rad/s, and relaxation frequency, γ=2.5×10¹³ rad/s. FIG. 4 shows the evolution of the computed radiative heat flux as a function of the distance d separating the two silver mediums 1, 2. The graphic illustration in FIG. 4 distinguishes the far field and near field contributions for both s and p-polarizations. The graph in FIG. 4 also illustrates how the heat flux is enhanced by several orders of magnitude in the near field when the distance d decreases to a distance equal to or smaller than the radiation peak wavelength, λₘₐₓ, which is given by Wien's displacement law (λₘₐₓT=2898 mm K), wherein T is either one of the temperature of the first medium 1 or the temperature of the second aluminum medium 2. It is also evident that, in the case of silver, the main contribution of the tunneling heat transfer is from the s-polarization.

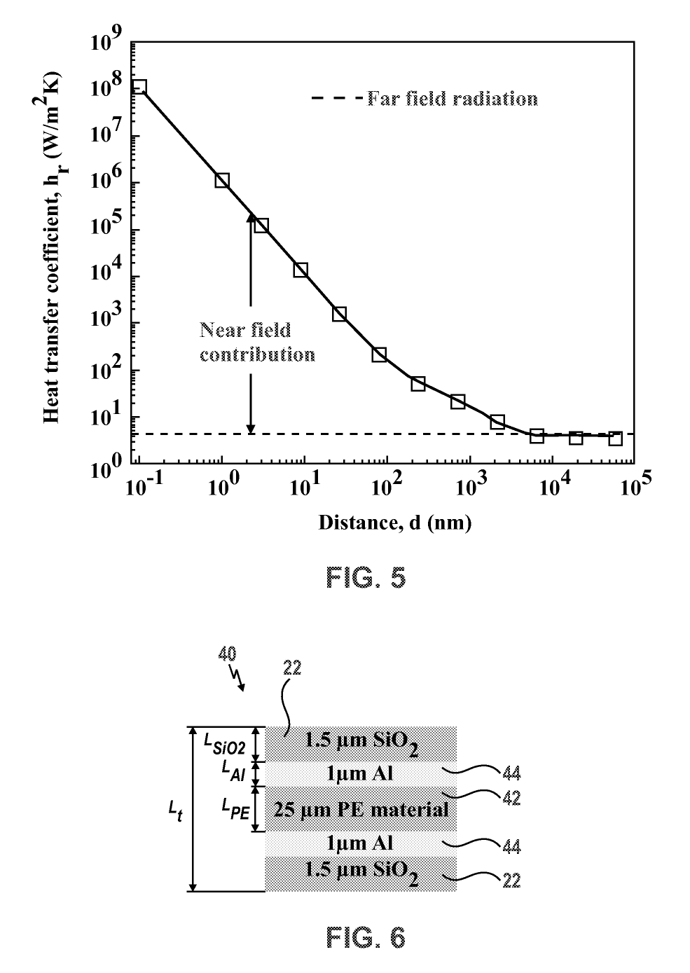

In another embodiment, the first medium 1 and the second medium 2 are made of silicon carbide (SiC) where the first SiC medium 1 is held at a temperature T₁=301 K and the second silver medium 2 is held at a temperature T₂=300 K. It is appreciated that the radiative heat flux between these SiC, i.e., dielectric material, mediums held at approximately 300 K can be even larger than that for silver. This is due to the dielectric constant of the SiC mediums, which enables a high coupling between the surface waves in the infrared part of the spectrum. In the present embodiment, the radiative heat transfer coefficient hᵣ can be defined as hᵣ(d)=lim_{T}_{₁}_{→T}_{₂}[q″_{1→2}(T₁,T₂,d)/(T₁−T₂)], where the parameters for the SiC mediums can be predicted using the Lorentz model where the plasma frequency, ωₚ=2.72×10¹⁴ rad/s, the oscillator frequency, ω₀=1.49×10¹⁴ rad/s, and the relaxation frequency, γ=8.97×10¹² rad/s. For comparison purposes, the radiative heat transfer coefficient at 300 K calculated from far-field radiation by the Stephan-Boltzmann can be given where the far-field radiation heat flux is expressed as q″_{1→2}=σ(T₁⁴−T₂⁴)/(2/α₁−1), where σ represents the Stefan-Boltzmann constant (σ=5.67×10⁻⁸ W/m²K⁴) and α₁=α₂ represents the total hemispherical emissivity of SiC material at 300 K such that α₁=0.83. FIG. 5 illustrates a graph depicting the heat transfer coefficient hᵣ between the two semi-infinite SiC mediums 1, 2, according to the present embodiment, as a function if the distance d between the first SiC medium 1 and the second SiC medium 2. As illustrated in FIG. 5, it is evident that the heat flux is enhanced by several orders of magnitude compared with the far-field radiative heat flux when the distance d between the first SiC medium 1 and the second SiC medium 2 becomes smaller than the maximum wavelength λₘₐₓ=10⁴ nm.

It is appreciated that the radiative heat flux between various other dielectric materials can also be larger than that for silver. By way of example, the radiative heat flux between SiO₂ mediums is greater than that for silver mediums. This increase in flux is due to the dielectric constant of the SiO₂ mediums, which enables a high coupling between the surface waves in the infrared part of the spectrum. The parameters for the SiO₂ mediums can be accurately predicted using the Lorentz model, where the parameters for the SiO₂ mediums are plasma frequency, ωₚ=1.696×10¹⁶ rad/s, oscillator frequency, ω₀=2.0×10¹⁴ rad/s, and relaxation frequency, γ=5.65×10¹² rad/s [50].

As mentioned above and as illustrated in FIG. 2, the PE plate 40 is generally comprised of a pyroelectric (PE) material film 42, with a thickness L_{PE}, sandwiched between electrodes 44, each with a thickness L_{Al}. The PE plate 40 may also be coated on both sides with silicon dioxide (SiO₂) thin films 22 of thickness L_{SiO}_{₂}. The inner surfaces of the hot plate 20 and the cold plate 30 may also be coated with SiO₂ thin films 22 of thickness L_{SiO}_{₂}. The SiO₂ thin films 22 act as absorbing layers, which emit and absorb nanoscale radiation to enhance the radiative heat transfer rate between the hot plate 20 and the cold plate 30, as mentioned above. As illustrated in FIG. 1, the total thickness of the PE plate 40 is Lₜ.

FIG. 6 illustrates one embodiment of the PE plate 40 comprising a PE material film 42 made of 60/40 porous vinylidene fluoride-trifluoroethylene (P(VDF-TrFE)) with a thickness L_{PE}=25 μm sandwiched between two aluminum electrodes 44 of thickness L_{Al}=1 μm. In the present embodiment, the Al electrodes 44 were coated with SiO₂ thin films 22 of thickness L_{SiO}_{₂}=1.5 μm to enhance the radiative heat flux, as previously discussed. Thus, the total thickness Lₜ of the composite PE plate 40 was 30 μm with the SiO₂ thin films 22 and 27 μm without the SiO₂ thin films 22.

In a preferred embodiment, PE material film 42 is made of pyroelectric material. As mentioned above, all ferroelectric materials are pyroelectric. The polarization of ferroelectric materials vanishes beyond the Curie temperature (T_{Curie}) when the material undergoes a phase transition from ferroelectric to paraelectric and the spontaneous polarization disappears. It is understood that this phase transition process from ferroelectric to paraelectric results in a large charge release. It is appreciated that a large number of PE materials exist and can be used to make the PE material film. By way of example, PE materials include minerals (e.g., tour-maline), single crystals (e.g., triglycine sulfate, lead magnesium niobate-lead titanate (PMN-PT), lead zirconate niobate-lead titanate (PZN-PT), or various ratios of PMN-PT and PZN-PT), ceramics (e.g., lead zirconate titanate (PZT), barium titanate (BaTiO₃), or lithium titanate (LiTiO₃)), polymers, and LiNbO₃. It is appreciated the PE materials can also be created synthetically, usually in the form of thin films, such as P(VDF-TrFE) or polyvinylidene fluoride trifluoroethylene chlorofluoroethylene (P(VDF-TrFE-CFE)). P(VDF-TrFE) is ferroelectric and of particular interest as it undergoes a phase transition from ferroelectric to paraelectric at low Curie temperature around 65.7° C. P(VDF-TrFE) is also particularly interesting because it recovers its polarization upon cooling unlike pure PVDF, it can be conveniently spin-coated, it has 25 times greater dielectric strength than ceramics which is a significant advantage, and it features low Curie temperature which can be tuned by changing the VDF-TrFE ratio. Similarly, lead zirconate stannate titanate (PZST) thin films can be synthesized with various compositions in which Ti⁴⁺ is substituted by Sn⁴⁺ to achieve different Curie temperatures.

The PE material film 42 is preferably made of P(VDF-TrFE). In one embodiment, the PE material film 42 can be made of a 60/40 P(VDF-TrFE) dense film prepared from commercial copolymer of 60/40 P(VDF-TrFE) pellets using a hydraulic press, a hot plate, and two steel dies. To form the 60/40 P(VDF-TrFE) dense film using this process, the two steel dies were heated on the hot plate, which can be made of an aluminum plate hosting a 100 W cartridge heater, until the temperature reached 185° C. The two steel dies can be covered with two sheets of Kapton® HN film, which can be used to prevent the copolymer of 60/40 P(VDF-TrFE) from sticking to the steel dies. Then, a single 60/40 P(VDF-TrFE) pellet, about 4 mm in length and 2 mm in diameter, was placed between the steel dies and transferred to the hydraulic press where a load of ˜8900 N (˜2000 lb) was applied. The temperature was kept constant at 185° C. for 2 minutes and then the hot plate was turned off. After the temperature of the steel dies decreased below 70° C., the load was removed. The resulting 60/40 P(VDF-TrFE) film was approximately 50 μm thick. Next, the 60/40 P(VDF-TrFE) film was baked in a vacuum oven at 130° C. and approximately 1 Torr (133 Pa) for 24 hours to remove solvents and volatile impurities, and to improve both the dielectric strength and resistivity.

In another embodiment, a 10 nm thick titanium film can be deposited onto both sides of the 60/40 P(VDF-TrFE) film as an adhesion layer for the subsequent deposition of 1 μm thick aluminum electrodes 44. The deposition of the thick titanium film and the thick aluminum electrodes 44 can be achieved by electron beam evaporation. A wire can be attached to the aluminum electrodes 44 on each side of the 60/40 P(VDF-TrFE) film using copper tape. A type J thermocouple can also be attached to the 60/40 P(VDF-TrFE) film in such a way that it is in thermal, but not in electrical, contact with the electrodes 44. In another embodiment, two slabs of concrete can be placed below the hot plate and above the top die, which can act as thermal insulation to prevent the dies from cooling too quickly.

It is appreciated that the PE material film 42 can be made of purified copolymer 60/40 P(VDF-TrFE) films wherein commercial copolymer 60/40 P(VDF-TrFE) is purified by solvent extraction to reduce leakage current and to increase the film resistivity at high temperatures and applied voltages caused by the presence of impurities. To form the purified 60/40 P(VDF-TrFE) films using this process, 0.5 g of commercial 60/40 P(VDF-TrFE) pellets were dissolved in 12 ml of methyl ethyl ketone (MEK, 99.6%) in a small glass beaker to create a homogeneous solution. The solution was continuously stirred at 70° C. for approximately 45 minutes. When all of the copolymer 60/40 P(VDF-TrFE) dissolved, the temperature was increased to 140° C. and the solution was boiled for 20 minutes to increase its viscosity. Next, the viscous solution was poured into a separatory funnel containing 100 ml of anhydrous ethanol (EtOH). The mixture was then vigorously shaken and left to sit for 3 hours to allow the copolymer 60/40 P(VDF-TrFE) particulate to precipitate and separate from the solvent. Then, the copolymer 60/40 P(VDF-TrFE) was drained from the bottom of the separatory funnel onto filter paper, wherein the copolymer 60/40 P(VDF-TrFE) precipitated as gel after approximately 3 hours. The gel was thoroughly rinsed with EtOH and then the gel was air dried in an oven at 50° C. and atmospheric pressure for 3 hours and further air dried at room temperature in a fume hood for three days. The solid copolymer 60/40 P(VDF-TrFE) gel was then cut into small pieces. The small pieces were then formed into 60/40 P(VDF-TrFE) dense films using the process described above utilizing a hydraulic press, a hot plate, and two steel dies. In another embodiment, electrodes 44 can be deposited and wires can be attached to the purified 60/40 P(VDF-TrFE) dense films, as explained above.

It is appreciated that the PE material film 42 can be made of porous and nonporous 60/40 P(VDF-TrFE) thin films, wherein a phase inversion process is applied to commercial copolymer 60/40 P(VDF-TrFE) material to create the porous and nonporous polymer P(VDF-TrFE) thin films. The phase inversion process allows for the controlled conversion of a polymer from a liquid to a solid state. According to the present process, 0.5 g of the commercial P(VDF-TrFE) pellets were cut into small pieces, to reduce dissolving time, and were dissolved in ˜3.5 ml of MEK in a small glass beaker to create a 15 wt % solution of P(VDF-TrFE). The mixture was heated and continuously stirred at 50° C. The mixture can be covered with aluminum foil to reduce solvent evaporation. Once the P(VDF-TrFE) pellets completely dissolved (after ˜30 min), the resulting viscous solution was poured onto a substrate, which can consist of a 2 inch silicon wafer wrapped in aluminum foil. The aluminum-covered wafer can be baked at 150° C. for at least 10 minutes to remove moisture and increase the subsequent adhesion of the copolymer P(VDF-TrFE) film. After the viscous solution was poured onto the substrate, it was spin-coated at 500 rpm for 60 seconds to create an approximately 11 μm P(VDF-TrFE) thick film. The wafer was submerged into a non-solvent made of ˜80 ml of EtOH at approximately 4° C. for 30 seconds to undergo phase inversion. Then, the P(VDF-TrFE) thick film was rinsed in a large beaker filled with 400 ml of EtOH acting as non-solvent and continuously stirred at room temperature for 48 hours to remove the remaining solvent from the P(VDF-TrFE) thick film. The P(VDF-TrFE) thick film was peeled off from the aluminum-foil-covered wafer with tweezers, air dried in a fume hood for an additional 24 hours and then vacuum baked at approximately 1 Torr and 130° C. for 24 hours to remove any residual solvent. In another embodiment, aluminum electrodes, wires and a thermocouple can be attached to the P(VDF-TrFE) thick film using the same procedure described for the commercial and purified P(VDF-TrFE) films.

It is appreciated that the purification process and the phase inversion process can be applied to other compositions of P(VDF-TrFE) having different VDF-TrFE ratios. It is also appreciated that the purification process and the phase inversion process can be applied to other PE polymers including other copolymers as well as ter-polymers, such as poly(vinylidene fluoride-trifluoroethylene-chlorofluoroethylene) (P(VDF-TrFE-CFE)), which can also have various compositions.

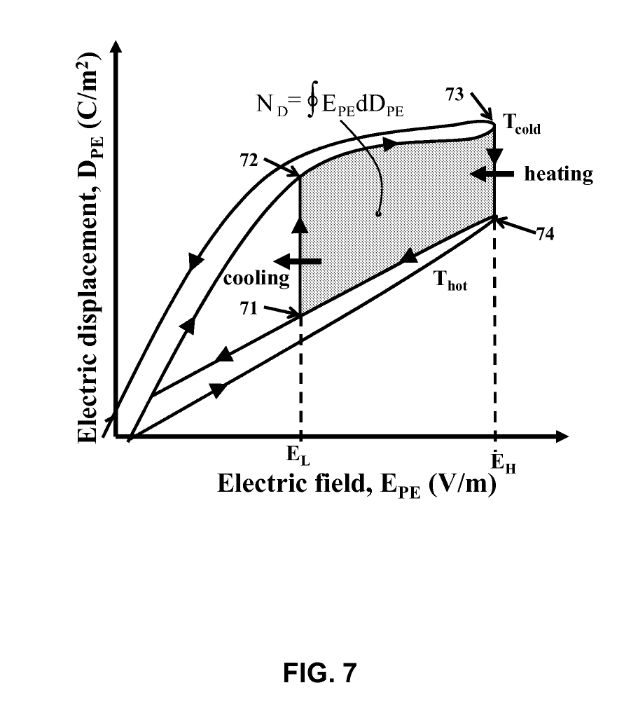

In operation of the converter 10, the PE plate 40 can also be subjected to a thermodynamic cycle to convert heat waste to electrical energy. In one embodiment, the PE plate 40 can be subjected to the Olsen cycle (also called the Ericsson cycle). The Olsen cycle, applied to PE materials, consists of two isothermal and two isoelectric field processes. FIG. 7 illustrates a typical Olsen cycle in the electric displacement versus electric field diagram (D-E diagram) for a typical PE material. The shaded area enclosed by the Olsen cycle is the electrical energy produced per unit volume of the particular PE material per cycle. From a first point 71 to a second point 72, the electric field on the PE material is increased from E_{L} to E_{H} isothermally at temperature T_{cold}. The process from the second point 72 to a third point 73 corresponds to heating of the PE material from temperature T_{cold} to Tₕₒₜ under constant electric field E_{H}. The process from the third point 73 to a fourth point 74 consists of reducing the electric field from E_{H} to E_{L} under isothermal conditions at Tₕₒₜ. Finally, the cycle is closed from the fourth point 74 to the first point 71 by cooling the PE material to T_{cold} under constant electric field E_{L}. In brief, the principle of the Olsen cycle is to charge a capacitor made of PE material through cooling under low electric field and to discharge it through heating under higher field. The Olsen cycle was experimentally performed and on three different types of 60/40 P(VDF-TrFE) copolymer samples, namely commercial P(VDF-TrFE) films, purified P(VDF-TrFE) films, and porous P(VDF-TrFE) films, and these experiments are shown and described in Navid, A & Pilon, L., “Pyroelectric Energy Harvesting Using Olsen Cycles in Purified and Porous Poly(Vinylidene Fluoride-Trifluoroethylene) [P(VDF-TrFE)] Thin Films,” Smart Mater. Struct. 20 025012 (2011), which is incorporated herein by reference.

It is appreciated that the PE plate 40 can be subjected to various other thermodynamic cycles capable of converting waste heat to electrical energy. By way of example, the PE plate 40 can be subjected to the Clingman cycle, or any other suitable power cycle in the D-E diagram.

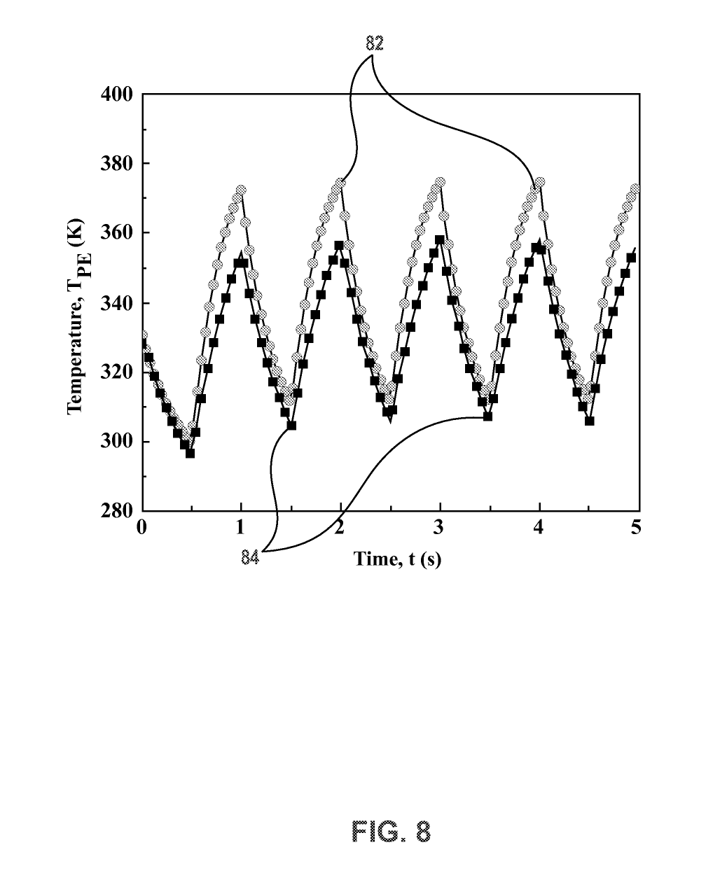

It is expected that the SiO₂ absorbing layer thin films 22 have an effect on the converter 10 performance. Temperature oscillations were simulated on one embodiment of the PE plate 40 comprising of a PE material film 42 made of 60/40 P(VDF-TrFE) sandwiched between the electrodes 44 made of aluminum. The temperature oscillation simulation was performed on two embodiments of the PE plate 40: one embodiment of the PE plate 40 coated with 1.5 μm thick SiO₂ thin films 22, as illustrated in FIG. 6, and another embodiment of the PE plate 40 without the SiO₂ thin films 22. According to the simulation, the converter 10 was operated at a frequency f=1 Hz with the cold plate 30 temperature at T_{c}=273 K and the hot plate 20 temperature at Tₕ=388 K. FIG. 8 illustrates a first plot 82 of the corresponding temperature variations of the PE plate 40 with SiO₂ absorbing layer thin films 22 and a second plot 84 of the corresponding temperature variations of the PE plate without SiO₂ absorbing layer thin films 22. As illustrated by the first plot 82, the first embodiment of the PE plate 40 with SiO₂ absorbing layer thin films 22 underwent a temperature swing of ΔT_{TE}=63 K while the second embodiment of the PE plate 40 without SiO₂ absorbing layer thin films 22 underwent a temperature swing of ΔT_{TE}=50 K, as illustrated by the second plot 84. According to the simulation, the presence of SiO₂ absorbing layer thin films 22 on the PE plate 40 enhanced the nanoscale radiative heat transfer from the cold plate 30 and the hot plate 20 to the PE plate 40. This, in turn, increases the amplitude of the PE plate 40 temperature oscillations. It also resulted in a higher operating frequency and a larger power density.

In operation, the converter 10, according to the present embodiment, is governed by the energy conservation equation of Equation (1). The effective volumetric heat capacity (ρcₚ)_{eff} of the present embodiment can be expressed as:

$${( ρ {c}_{p} )}_{eff} = \frac{1}{{L}_{t}} [ {( ρ {c}_{p} )}_{PE} {L}_{PE} + {( ρ {c}_{p} )}_{Al} {L}_{Al} + 2 {( ρ {c}_{p} )}_{{SiO}_{2}} {L}_{{SiO}_{2}} ] \qquad ( 8 )$$

where (ρcₚ)_{PE} is the volumetric heat capacity of the PE plate 40, (ρcₚ)_{Al} is the volumetric heat capacity of the aluminum (Al) cold plate 20 and hot plate 30, and (ρcₚ)_{SiO}_{₂} is the volumetric heat capacity of the SiO₂ material. For the present embodiment of the PE plate 40 made of 60/40 P(VDF-TrFE) coated with SiO₂ absorbing layer thin films 22, where ρ_{PE}=1930 kg/m³ and c_{p,PE}=1200 J/kgK, the volumetric heat capacity, (ρcₚ)_{eff}, is equal to 2.31×10⁶ J/m³K. When the PE plate 40 does not comprise the SiO₂ absorbing layer thin films 22, the volumetric heat capacity, (ρcₚ)_{eff}, is equal to 2.33×10⁶ J/m³K.

According to the present embodiment of converter 10, the net radiative heat transfer flux from the Al hot plate 20 to the P(VDF-TrFE) PE plate 40, q″_{h→PE}, and the net radiative heat transfer flux from the P(VDF-TrFE) PE plate 40 to the Al cold plate 30, q″_{PE→c}, can be computed from Equations (2) to (5) for the respective distances d and the PE film temperature T_{PE}(t). Then Equation (1) can be solved for the P(VDF-TrFE) PE plate 40 temperature T_{PE}(t) as a function of time.

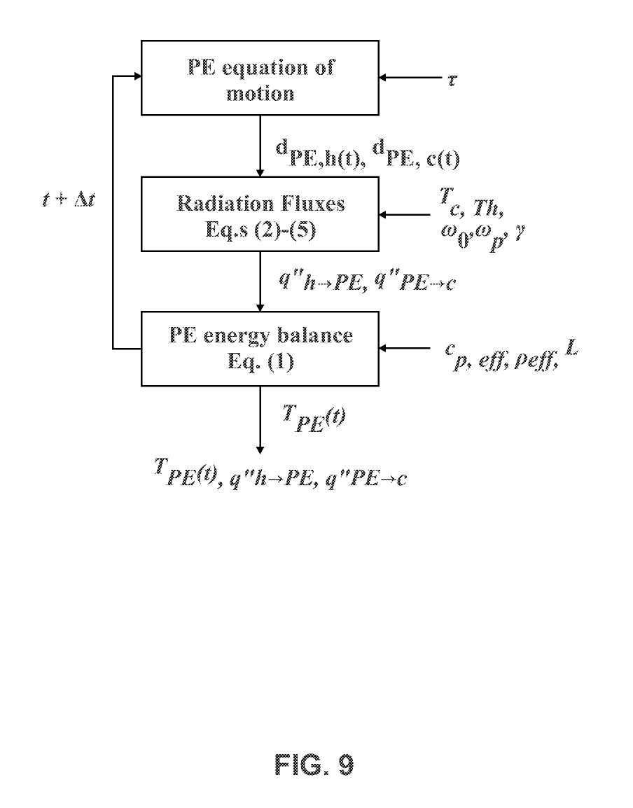

FIG. 9 shows the block diagram of the solution procedure. The PE plate temperature T_{PE}(t) can be determined by solving the energy conservation equation of Equation (1). Equation (1) can be solved numerically for T_{PE}(t) using finite-difference method based on the forward-difference approximation for the time derivative. This yields the following explicit expression for T_{PE} at time t+Δt knowing its value at time t:

$${T}_{PE} ( t + Δ t ) = {T}_{PE} ( t ) + \frac{{q}_{h -> PE}^{″} ( {T}_{h} , {T}_{PE} ( t ) , {d}_{PE , h} ( t ) ) - {q}_{PE -> c}^{″} ( {T}_{PE} ( t ) , {T}_{c} , {d}_{PE , c} ( t ) )}{{( ρ {c}_{p} )}_{eff} {L}_{t}} Δ t \qquad ( 9 )$$

where Δt represents the time step. The radiation fluxes q″_{h→PE}(Tₕ,T_{PE}(t),d_{PE,h}(t)) and q″_{PE→c}(T_{PE}(t),T_{c},d_{PE,c}(t)) can be computed numerically at every time step according to Equations (2) to (5) where the integrals over frequency ω and over the x-component of the wavevector q can be performed using Simpson ⅜ rule. Integration over ω from 0 to infinity can then be performed up to ω=N_{ω}k_{B}T₁/ where k_{B} represents the Boltzmann's constant and =h/2π where h is the Planck's constant (h=6.63×10⁻³⁴ J·s). Integration over q from ω/c to infinity can be performed up to q=N_{q}ω/c. It is appreciated that N_{ω} and N_{q} are the numbers of frequencies and wavevectors considered in the calculation. Numerical convergence for the radiation fluxes, q″_{h→PE} and q″_{PE→c}, can be established by reducing Δω and Δq and increasing N_{ω} and N_{q} by a factor of 1.3 until the numerical results do not vary by less than 0.1% for the heat fluxes q″_{h→PE} and q″_{PE→c}. Numerical convergence for T_{PE}(t) can then be established by reducing Δt by a factor of 1.6 until the results do not vary by less than 1% for all time steps.

To proceed with the solution procedure of FIG. 9, it is appreciated that the initial PE plate 40 temperature T_{PE} at time t=0 should be set to be T_{PE}(t=0)=(T_{c}+Tₕ)/2. In one embodiment, the PE plate 40 oscillates at a frequency f between the hot plate 20 and the cold plate 30, which are separated by a gap of 100 μm and maintained at constant temperatures Tₕ and T_{c}, respectively. Also, the distances d_{PE,h} and d_{PE,c} are characterized as step functions of time and oscillates at a frequency of f. It is also appreciated that according to the present embodiment, the spatial relationships of the converter 10 can be expressed as, Lₜ+d_{PE,h}(t)+d_{PE,c}(t)=100 μm. The minimum value of the distances d_{PE,h} and d_{PE,c} can be arbitrarily set at 100 nm, ensuring that the near-field radiative heat transfer dominates radiation transfer successively between the PE plate 40 and the cold plate 30 and the hot plate 20. The PE plate 40 oscillation can be achieved using conventional piezoelectric actuators 50. Further, the initial position of the PE plate 40 was positioned in such a way that d_{PE,c}(t=0)=100 nm.

In order to assess the performance of the converter 10, the average thermodynamic efficiency over a cycle can be defined as:

$$η = \frac{{\dot{W}}_{e} - {\dot{W}}_{p}}{{\dot{Q}}_{in}} \qquad ( 10 )$$

where \dot{W}ₑ represents the electric power generated by the PE plate 40 and \dot{W}ₚ represents the power provided by the piezoactuator pillars 50, both per unit surface area of the PE plate 40 and expressed in W/m². The heat flux (in W/m²) provided by the hot plate 20 to the PE plate 40 over one cycle of period τ can be denoted by \dot{Q}ᵢₙ and expressed as:

$${\dot{Q}}_{in} = \frac{1}{τ} {\int }_{0}^{τ} {q}_{h -> PE}^{″} ( {T}_{h} , {T}_{PE} , {d}_{PE , h} ( t ) ) d τ \qquad ( 11 )$$

where τ=1/f represents the oscillation period.

In order to estimate the power, \dot{W}ₚ, provided by the piezoactuator pillars 50, the pressure balance on the PE plate 40 can be performed. The main forces affecting the motion of the PE plate 40 are the gravitational force, the Casimir force, the van der Waals force, and the radiation pressure force.

Assuming that the oscillation of the PE plate 40 is vertical, the gravitational force acting on the PE plate 40 has to be overcome by the actuators 50. The gravitational force per unit surface area is given by P_{g}=ρ_{eff}Lₜg where g is the gravitational acceleration (g=9.81 m/s²). When the PE plate 40 thickness is Lₜ=30 μm and its effective density is ρ_{eff}=2.10 g/cm³, the gravitational pressure P_{g} can be expected to be about 0.6 Pa.

The Casimir force is an attractive force between surfaces caused by the quantum fluctuations in the zero point electromagnetic field. When the parallel plates get close to each other, the Casimir force, which is negligible at macroscale, becomes important. The attractive Casimir force per unit surface area for semi-infinite parallel metallic plates can be expressed as P_{c}=−π²c/240d⁴. Thus, the Casimir force acting between two metallic plane-parallel plates, such as Aluminum, with a distance d=100 nm between the two plates, amounts to 13 Pa. When the two plates are made of dielectric materials (e.g., SiO₂ and SiC) the Casimir force is typically smaller by one order of magnitude. Moreover, if the two plates are not perfectly parallel and the closest distance between them is the same as the distance between parallel plates, the Casimir force will be even lower.

The van der Waals force is often responsible for adhesion in microscale devices. For two parallel flat plates in vacuum, the van der Waals pressure can be expressed as Pᵥ=−H/12πd², where H is the Hamaker constant and d is the distance separating the two surfaces. The Hamaker constant of most condensed phases with an interaction across the vacuum typically ranges from 0.4 to 4×10⁻¹⁹ J. According to the present embodiment, the minimum distance between the PE plate 40 and the hot plate 20 and cold plate 30 can be assumed to be 100 nm. The adhesive pressure due to the van der Waals force can be expected to be less than 1×10⁻⁶ Pa.

The radiation pressure on two parallel plates can be given by P_{rad}=\dot{Q}ᵢₙ/c. According to the present embodiment, the magnitude of average heat transfer rate \dot{Q}ᵢₙ is expected to be about 1 W/cm², corresponding to a radiation pressure around 10⁻⁵ Pa.

Consequently, both the radiation pressure P_{rad} and the van der Waals pressure Pᵥ are negligible compared with the gravitational force P_{g} and the attractive Casimir force P_{c}. The time-averaged oscillation power \dot{W}ₚ per unit surface area needed from the actuators 50 can be expressed as:

$${\dot{W}}_{p} = \frac{2}{τ} {\int }_{{z}_{1}}^{{z}_{2}} ( {P}_{g} / 2 + {P}_{c} ) d z \qquad ( 12 )$$

where τ is the oscillation period, z₁ is the minimum gap distance between the PE plate 40 and the cold plate 30, z₁=d_{PE,c}(t=0)=0.1 μm, and z₂ is the maximum gap distance between the PE plate 40 and the cold plate 30, z₂=d_{PE,c}(t=τ/2)=69.9 μm. It is appreciated that the gravitational pressure P_{g} needs to be overcome only in the ascending motion of the PE plate 40.

The electrical energy density N_{D} can be defined as the electrical energy generated per cycle and per unit volume of the PE plate 40 and can be determined experimentally by operating the Olsen cycle across the phase transition interval between temperatures Tₚ₁ and Tₚ₂. Then, the electrical power density generated by the converter 10 at a given frequency can be estimated if the energy density N_{D} is assumed to be constant and equal to the energy density N_{D} generated by operating the Olsen cycle across the phase transition, as long as the operating temperature span is wider than the phase transition interval between Tₚ₁ and Tₚ₂. It is appreciated that this assumption can be supported by the fact that PE materials that are also ferroelectric exhibits a very large charge redistribution across the phase transition from the ferroelectric phase to the paraelectric phase, where a large part of the energy density N_{D} produced at every cycle can be contributed from this phase transition. When the thickness of the PE material film 42 is denoted by L_{PE}, the electrical power generated at frequency f per unit surface area of the PE plate is given by:

\dot{W}ₑ=fL_{PE}N_{D} (13)

As mentioned above, the energy density N_{D} of the converter 10 can be assumed to be constant as long as the converter 10 is operated across the phase transition interval between temperatures Tₚ₁ and Tₚ₂ of the PE material film 42. Therefore, increasing the frequency of temperature oscillation in the PE plate 40 tends to increase the power density of the converter 10. In one embodiment, the Olsen cycle using a PE material film 42 made of 60/40 P(VDF-TrFE) was experimentally performed across the phase transition of the PE material film 42 occurring between temperature Tₚ₁=313 K and Tₚ₂=370 K, which corresponds to a ΔT_{TE}=57 K with T_{Curie}=348 K and an energy density N_{D} of 279 J/L.

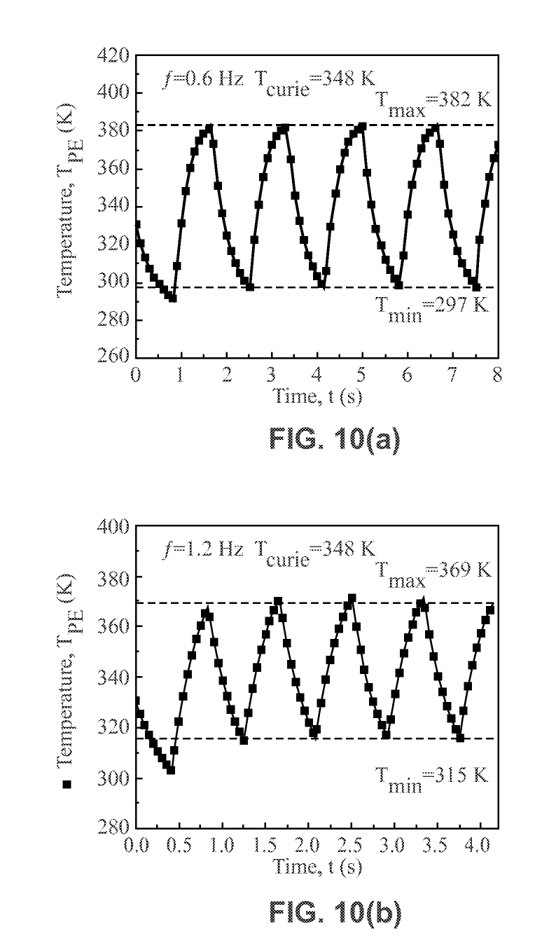

FIG. 10(a) illustrates the temperature of the PE plate 40 as a function of time at a frequency f=0.6 Hz when the temperature of the cold plate 30 is T_{c}=273 K and the temperature of the hot plate 20 is Tₕ=388 K. As illustrated in FIG. 10(a), the temperature of the PE plate 40 oscillated between minimum and maximum temperatures Tₘᵢₙ=297 K and Tₘₐₓ=382 K across the Curie temperature T_{curie}=348 K ensuring a complete phase transition. Similarly, FIG. 10(b) shows that the temperature of the PE plate 40 oscillated between minimum and maximum temperatures Tₘᵢₙ=315 K and Tₘₐₓ=369 K across the Curie temperature T_{Curie}=348 K at a frequency f=1.2 Hz. As illustrated in FIGS. 10(a)-(b), the amplitude of the temperature oscillation of the PE plate 40 decreased as the frequency increased. This result suggests that it is possible to achieve the desired temperature oscillation across the phase transition at a substantially high frequency.

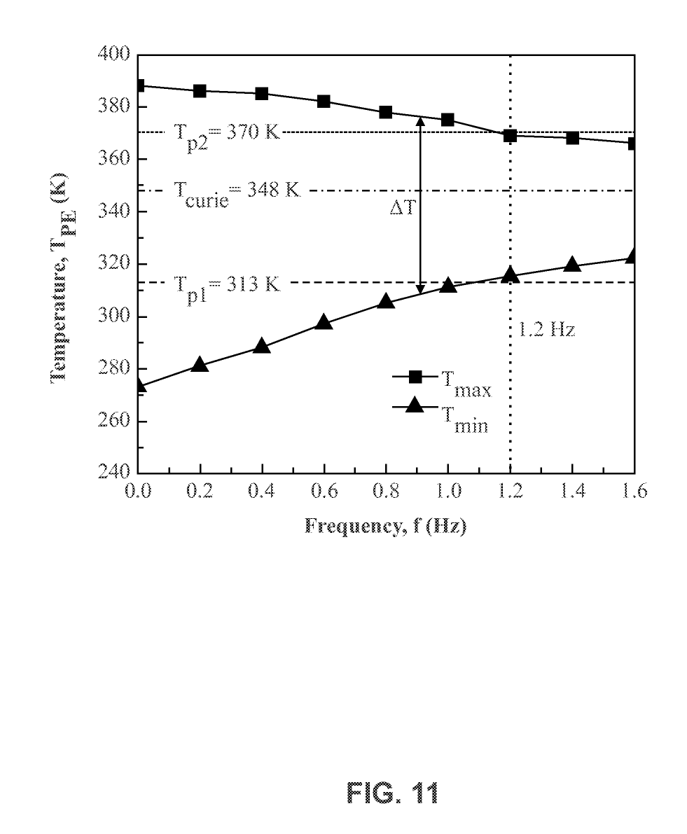

In order to identify the largest frequency at which the temperature oscillation covers the phase transition, different frequencies were examined. FIG. 11 shows the maximum and minimum temperatures reached by the PE plate 40 when the PE material film 42 is made of 60/40 P(VDF-TrFE) with SiO₂ absorbing layer thin films 22 as a function of frequency. As illustrated in FIG. 11, the PE plate 40 experienced temperature oscillations from below 313 K to above 370 K for frequencies less than 1.2 Hz, thus, covering the phase transition region. According to Equation (13), the maximum power output per unit surface area achieved was 0.84 mW/cm² when the frequency, f=1.2 Hz.

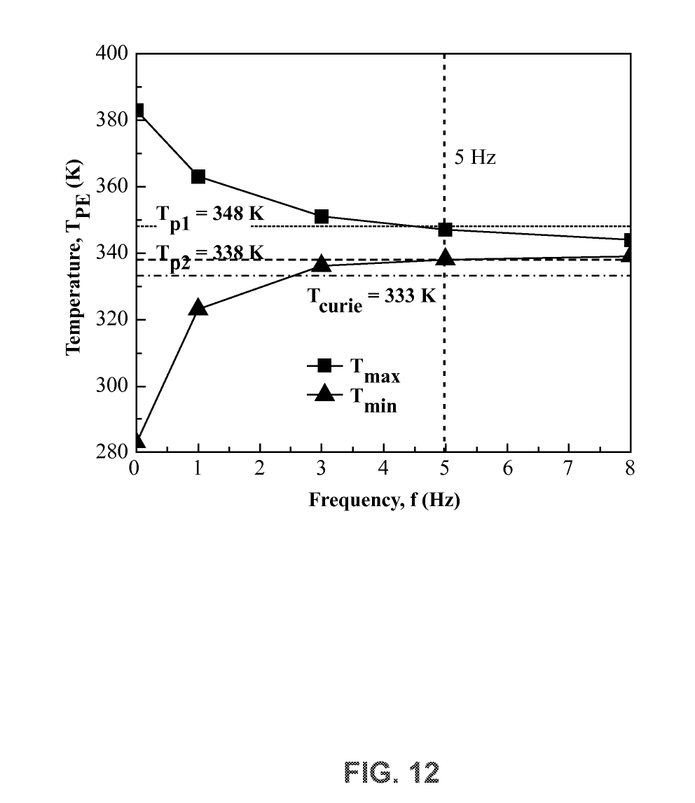

It is also appreciated that the power density of the converter 10 can be further increased by choosing a PE material for the PE material film 42 exhibiting a very strong electrocaloric effect. The electrocaloric effect is the change in temperature caused by a change in an applied electric field under adiabatic conditions. By way of example, the composite thin film 0.9 lead magnesium niobate-lead titanate (0.9 PMN-PT) features a volumetric heat capacity of (ρcₚ)_{PE}=3×10⁶ J/m³·K and an energy density of 432 J/L for a 10 K temperature variation from Tₚ₁=338 K to Tₚ₂=348 K. Although such temperature interval is beyond the material Curie temperature of 333 K, it is still possible to generate a very large energy density due to the highly nonlinear behavior near that temperature. However, it is appreciated that such composite films should be very thin in order to sustain very large electric fields and thus convert more heat into electric energy. To achieve large power output per unit surface area with such a composite material, one embodiment of the PE plate 40 can be made of 100 layers of 300 nm 0.9PMN-PT thin films, wherein each layer of 300 nm 0.9PMN-PT thin film is separated by 50 nm aluminum electrodes. According to the present embodiment, the overall thicknesses of the PE material thin film 42 and aluminum electrodes 44 were L_{PE}=30 μm and L_{Al}=5 μm, respectively. A 1.5 μm thick SiO₂ absorbing layer thin film 22 can also be coated on both sides of the composite PE plate 40. Therefore, the overall PE plate 40 thickness is Lₜ=38 μm and the effective volumetric heat capacity is (ρcₚ)_{eff}=2.82×10⁶ J/m³·K. The temperatures of the cold plate 30 and the hot plate 20 can be T_{c}=283 K and Tₕ=383 K, respectively, in order to achieve proper temperature oscillation. FIG. 12 illustrates the maximum and minimum temperatures of oscillation of the PE plate 40 as a function of frequency when the PE plate 40 comprises the PE material thin film 42 made of 0.9 PMN-PT PE material. When the reported energy density N_{D}=432 J/L for 10 K temperature oscillations is given, the electrical power density \dot{W}ₑ of the present embodiment can be estimated to be 6.5 mW/cm² at the working frequency of 5 Hz.

The Carnot efficiency is the maximum thermodynamic efficiency that can be theoretically achieved by a power cycle consisting of reversible processes and operating between two thermal reservoirs at temperatures T_{c} and Tₕ (in Kelvin). It can be expressed as:

$${η}_{Carnot} = 1 - \frac{{T}_{c}}{{T}_{h}} \qquad ( 14 )$$

Alternatively, the Curzon-Ahlborn efficiency η_{CA} represents the efficiency at maximum power production of heat engines, which only considers the irreversibility of finite rate heat transfer between thermal sources and working fluids (endoreversible engines). The Curzon-Ahlborn efficiency η_{CA} can be expressed as:

$${η}_{CA} = 1 - \sqrt{\frac{{T}_{c}}{{T}_{h}}} \qquad ( 15 )$$

To assess the performance of the converter 10, it is instructive to compare the efficiency of the device with both η_{Carnot} and η_{CA}.

To assess the device efficiency, the input power \dot{W}ₚ consumed to oscillate the PE plate 40 between the hot source 20 and cold source 30 can be estimated. According to Equation (12), the input oscillation power can be estimated to be less than 10 μW/cm² for PE material film 42 made of P(VDF-TrFE) at a frequency of 1 Hz. Thus, the electrical power generated \dot{W}ₑ is two orders of magnitude larger than the input power \dot{W}ₚ which can thus be neglected. It is appreciated that similar results can be found when the PE material film 42 is made of the 0.9PMN-PT thin film. Consequently, the maximum energy efficiency of the device η, defined by Equation (10), is capable of reaching up to 0.2% at a frequency f=1.2 Hz for a PE plate 40 comprising PE material film 42 made of 60/40 P(VDF-TrFE). On the other hand, using the 0.9PMN-PT composite thin films results in an efficiency of 1.3% at a frequency f=5 Hz for a 10 K temperature difference.

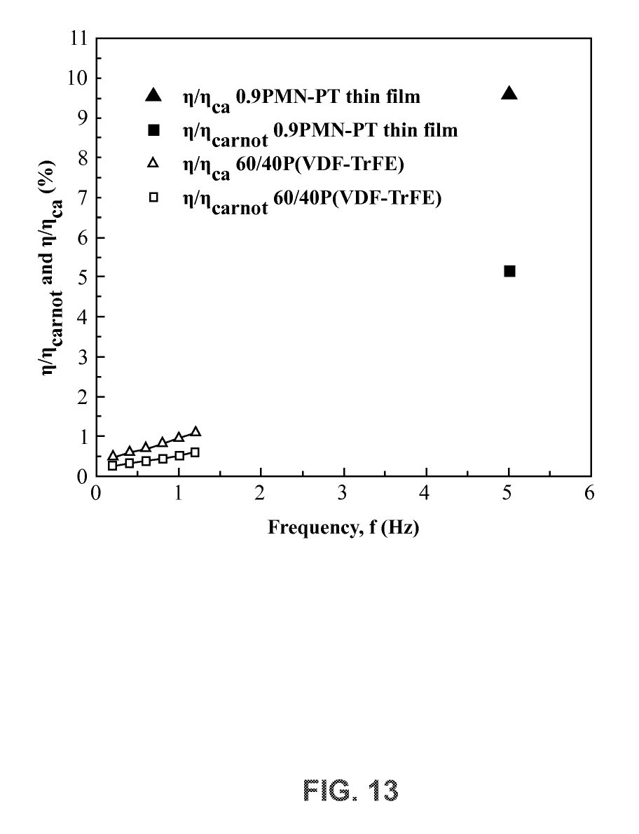

FIG. 13 shows the efficiency ratios η/η_{Carnot} and η/η_{CA} as a function of frequency for one embodiment of the PE plate 40 comprising the PE material film 42 made of a single 60/40 P(VDF-TrFE) film and another embodiment of the PE plate 40 comprising multiple PE material films 42 made of 0.9PMN-PT with their electrodes 44. As illustrated in FIG. 13, when the PE material film 42 is made of the copolymer P(VDF-TrFE) at the operating frequency of 1.2 Hz with 57 K temperature oscillation amplitude, up to 0.6% of the Carnot efficiency or 1.2% of the Curzon-Ahlborn efficiency can be achieved between a cold plate 30 temperature T_{c}=273 K and a hot plate 20 temperature Tₕ=388 K. As for the embodiment of the PE plate 40 comprising multiple PE material films 42 made of 0.9PMN-PT, the efficiency at the operating frequency of 5 Hz for a 10 K temperature oscillation amplitude corresponds to 5% of the Carnot efficiency and 10% of the Curzon-Ahlborn efficiency for temperatures a cold plate 30 temperature T_{c}=283 K and a hot plate 20 temperature Tₕ=383 K.

It is appreciated that the embodiment of the converter 10 having a PE plate 40 comprising the PE material thin film 42 made of 0.9PMN-PT material may also feature an even larger energy density if the converter 10 is operated across the whole phase transition temperature interval of the PE material thin film 42 made of 0.9PMN-PT, taking advantage of the nonlinear effect around the Curie temperature. According to the present embodiment, the device 10 is capable of experiencing a larger power output and higher efficiency. Alternatively, synthesis and processing of pyroelectric/ferroelectric materials with a larger energy density N_{D} can also be implemented. In addition, a multistage PE plate 40 consisting of superimposed PE material films 42 having different Curie temperatures could be implemented to harvest more energy through a wider phase transition region and to further increase the output energy density and efficiency of the converter 10.

It is also appreciated that parallelism is not essential to the converter 10 operation and a gap distance between the cold source 30 and the hot source 20 smaller than 100 nm would result in larger temperature oscillations or operating frequencies for a given temperature swing. In turn, the power density and efficiency of the device would increase. Touching between the hot plate 20 and the cold plate 30, however, may not be beneficial since heat transfer would then be by conduction which is slow and limited by thermal contact resistance between the PE plate 40 and the cold plate 30 or the hot plate 20.

While the embodiments described herein are susceptible to various modifications and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the spirit and scope of the appended claims.

What is claimed is:

1. A pyroelectric energy converter for direct conversion of nanoscale thermal radiation to electrical energy, comprising:
hot and cold plane sources, wherein the hot plane source is at temperature Tₕ and the cold plane source is at temperature T_{c}, wherein Tₕ is greater than T_{c},
an oscillating pyroelectric plate comprising at least one pyroelectric material film sandwiched between first and second electrodes used to collect electric charges from the pyroelectric film and to apply an electric field, and
a plurality of actuators coupled to the pyroelectric plate enabling the pyroelectric plate to oscillate between the hot and cold plane sources, wherein the oscillating pyroelectric plate is movable between a first position in spaced relation with the cold plane source at a distance smaller than the radiation peak wavelength, λₘₐₓ, given by Wien's displacement law (λₘₐₓT=2898 mm K) wherein T is the temperature of the cold plane source, T_{c}, and a second position in spaced relation with the hot plane source at a distance smaller than the radiation peak wavelength, λₘₐₓ, wherein T is the temperature of the hot plane source, Tₕ.

2. The converter of claim 1 further comprising first and second absorbing thin films coupled to the first and second electrodes.

3. The converter of claim 2 wherein the first and second electrodes are made of electrically-conducting material.

4. The converter of claim 3 further comprising third and fourth absorbing thin films coupled to the hot and cold plane sources.

5. The converter of claim 4 wherein the first, second, third and fourth absorbing thin films are thin films made of one of SiO₂ or SiC.

6. The converter of claim 5 wherein the first, second, third and fourth absorbing thin films are configured to emit and absorb nanoscale radiation.

7. The converter of claim 6 wherein the hot and cold plane sources are made of one of aluminum, or copper.

8. The converter of claim 7 wherein the plurality of actuators are piezoelectric pillars.

9. The converter of claim 3 wherein the first and second electrodes are made of one of aluminum, gold, silver, nickel, chromium, or any of their alloys, or indium tin oxide.

10. A pyroelectric energy converter for direct conversion of nanoscale thermal radiation to electrical energy, comprising:
hot and cold plane sources, wherein the hot plane source is at temperature Tₕ and the cold plane source is at temperature T_{c}, wherein Tₕ is greater than T_{c},
an oscillating pyroelectric plate comprising at least one pyroelectric material film sandwiched between first and second electrodes used to collect electric charges from the pyroelectric film and to apply an electric field, and
a plurality of actuators coupled to the pyroelectric plate enabling the pyroelectric plate to oscillate between the hot and cold plane sources, wherein the oscillating pyroelectric plate is alternatively brought within thermal contact with the hot and cold plane sources.

11. The converter of claim 10 wherein the oscillating pyroelectric plate, the hot plane source, and the cold plane source are treated to minimize the thermal contact resistance between the oscillating pyroelectric plate and the hot and cold plane sources.

12. The converter of claim 11 wherein the treatment to minimize the thermal contact resistance between the oscillating pyroelectric plate and the hot and cold plane sources comprises one of high-thermal conductivity paste, lubricant, or a forest of carbon nanotubes applied to the oscillating pyroelectric plate, the hot plane source, and the cold plane source.

13. A method of converting nanoscale thermal radiation to electrical energy, comprising the steps of:
applying an electric field to a pyroelectric plate between a hot plane source and a cold plane source, wherein the hot plane source is at temperature Tₕ and the cold plane source is at temperature T_{c}, wherein Tₕ is greater than T_{c}, and wherein the pyroelectric plate comprises at least one pyroelectric material film sandwiched between first and second electrodes used to collect electric charges from the pyroelectric film and to apply an electric field, wherein the pyroelectric plate is coupled to a plurality of actuators enabling the pyroelectric plate to oscillate between the hot and cold plane sources, and
moving the pyroelectric plate from a first position in spaced relation with the cold plane source at a distance smaller than the radiation peak wavelength, λₘₐₓ, given by Wien's displacement law (λₘₐₓT=2898 mm K) wherein T is the temperature of the cold plane source, T_{c}, to a second position in spaced relation with the hot plane source at a distance smaller than the radiation peak wavelength, λₘₐₓ, wherein T is the temperature of the hot plane source, Tₕ.

14. The method of claim 13 wherein the step of moving the pyroelectric plate includes:
increasing the applied electric field on the pyroelectric plate from a first applied electric field, E_{L}, to a second applied electric field, E_{H}, while maintaining the pyroelectric plate at a first temperature, T_{cold}, wherein the first applied electric field, E_{L}, is lower than the second applied electric field, E_{H};
increasing the temperature of the pyroelectric plate from the first temperature, T_{cold}, to a second temperature, Tₕₒₜ, while maintaining the applied electric field on the pyroelectric plate at the second applied electric field, E_{H}, wherein the first temperature, T_{cold}, of the pyroelectric plate is lower than the second temperature, Tₕₒₜ, of the pyroelectric plate;
reducing the applied electric field on the pyroelectric plate from the second applied electric field, E_{H}, to the first applied electric field, E_{L}, while maintaining the pyroelectric plate at the second temperature, Tₕₒₜ; and
reducing the temperature of the pyroelectric plate from the second temperature, Tₕₒₜ, to the first temperature, T_{cold}, while maintaining the applied electric field on the pyroelectric plate at the first applied electric field, E_{L}.
